(19) United States
(12) Patent Application Publication
(10) Pub. No.: US 2006/0271967 A1
(43) Pub. Date: Nov. 30, 2006

(54) In-flight entertainment wireless audio transmitter/receiver system

(75) Inventor: Yan Kwan So, Hong Kong (HK)

Correspondence Address: GEORGE O. SAILE, 28 DAVIS A VENUE, POUGHKEEPSIE, NY, 12603, US

(73) Assignee: Nasaco Electronics (Hong Kong) Ltd.

(21) Appl. No.: 11/313,017

(22) Filed: Dec. 20, 2005

Related U.S. Application Data
(63) Continuation-in-part of application No. 11/139,727, filed on May 27, 2005.

(51) Int. Cl. H04N 7/18; H04N 7/16

(52) U.S. Cl. 725/76; 725/81; 725/62; 725/77

(57) ABSTRACT

A wireless in-flight entertainment distribution apparatus distributes audio signals within an aircraft. A connector receives an audio signal that is converted to digital data words. The digital data words are then collected into groups to form data packets which then formed into data frames. Transmission channels are chosen to have at least one fundamental frequency which is then modulated with the data frames received. The modulated fundamental frequency is amplified to drive a transducer such as an antenna to generate a transmission signal through a transmission media. The wireless in-flight entertainment distribution system further receives the transmission signal from the transmission media. The transmission signal is then demodulated, depacketized, and decoded to recover the audio signal. The recovered audio signal is then transmitted to the speaker. The in-flight distribution apparatus adheres to the Bluetooth protocol for the transmission and reception of the digitized audio signal.

This application is a Continuation-in-Part of U.S. patent application Ser. No. 11/139,727, filed May 27, 2005, assigned to the same assignee as the instant application, and which is herein incorporated by reference in its entirety.

### BACKGROUND OF THE INVENTION

1. Field of the Invention

This invention is generally related to electronic circuits and systems that transmit and receive digitally sampled analog signals. More particularly, this invention relates to electronic circuits and systems that transmit and receive digital audio signals. Even, more particularly, this invention relates to wireless distribution of in-flight entertainment audio signals to headphones worn by a passenger.

2. Description of Related Art

As shown in FIG. 1, in-flight entertainment systems within a passenger cabin 10 of an aircraft 15 have a distribution system 5 which contains recorded audio (musical) content. The content is reproduced as an analog audio signal transferred on a physical cabling distribution network 20 to each passenger seat 25. Referring to FIG. 2, the cabling distribution network is placed within each passenger seat such that it terminates in a “female” type connector 30 placed in the armrest 27. A “male” plug connector 35 is inserted into the female connector 30 to make contact with the cabling distribution network 20 of FIG. 1 to receive the analog audio signals. The male plug connector 35 is connected to a cable 40 which is connected to a set of headphones 45. The set of headphones 45 has a left speaker 47 and a right speaker 49 that are placed respectively on the left and right ears of a passenger for listening to the analog audio signal.

Generally, the analog audio signal is a stereo signal and one terminal of the male plug connector 35 has one terminal connected through the cable 40 to the left speaker 47 to provide a left audio signal A_{L} and a second terminal connected through the cable 40 to the right speaker 49 to provide the right audio signal A_{R}. Additionally, the armrest 27 of the seat 25 may have a switch for selecting various channels of analog audio signal. Each channel containing a pair of the left audio signal A_{L} and the right audio signal A_{R} and having a different audio content.

“In-flight Entertainment—White Paper”, B. Subramanian, Wipro Technologies, found www.wipro.com, describes use Bluetooth standards designed to handle data and voice transmissions used for laptop or for consumer devices like MP3 players, gaming machines, mobile phones, and Internet appliances for in-flight entertainment.

“Airplane Cabin Network Convergence”, Russert, Proceedings—17th DASC Digital Avionics Systems Conference, 1998 . . . , November 1998, vol. 2, pages: G18/1-G18/7 examines benefits and issues associated with converging cabin networks, and argues that creation of an open environment for development and deployment of services can prove worthwhile for all involved in in-flight. entertainment.

“Hooked Loop Antenna Concept for Bluetooth Headset Applications”, Jidhage, et al., IEEE Antennas and Propagation Society Symposium, June 2004, Vol. 4 pages: 3521-3524 presents the novel hooked loop antenna (HLA) concept. The HLA is suitable for Bluetooth headset applications and it has been implemented into the SonyEricsson HBH-60 headset. The SonyEricsson HBH series head sets are Bluetooth wireless headsets that generally communicate with Bluetooth enabled computers, MP3 players, and Personal Digital Assistants (PDA).

OPENBRAIN Technologies Co., Ltd. Of Korea manufactures the SONORIX Bluetooth Audio Player OBH-0100. It is stereo headphones which receives a Bluetooth digitized audio signal from Bluetooth enabled transmitters.

U.S. Pat. No. 5,832,024 (Schotz et al.) illustrates the wireless transfer of audio frequency analog signals created by devices such as an AM/FM tuner to speakers. This wireless transfer is generally accomplished by modulating a radio frequency (RF) carrier signal with the analog signal.

U.S. Patent Application 2002/0102,949 (Langer) describes an entertainment system remote control having an audio port. The remote control has a set of input controls to control an electronic device, including a volume control, which is used for entering commands to control the electronic device. The commands are sent to the electronic device using a transmitter. The remote control includes an integral receiver capable of reproducing a digitized audio signal received from the electronic device. The audio output is presented to a port for a headphone jack. When a headphone jack is inserted into the headphone port, the remote control transmits a mute command to the electronic device. Once a headphone jack is inserted into the port, the volume control is configured to control the audio output of the remote control.

U.S. Pat. No. 6,671,325 and U.S. Pat. No. 6,510,182 (Lee, et al.) describes a wireless infrared digital audio system for transmitting, receiving, recovering, and reproducing digitized samples of analog signals while concealing unrecoverable digitized samples of analog signals to maintain a level of fidelity in reproducing the analog signals.

U.S. Pat. No. 6,577,419 (Hall, et al.) describes a communications system for aircraft that includes an on-board network using optical frequencies for communications within the aircraft; the network includes personal communications devices and/or other devices such as personal computers communicating via optical ports at infrared or other optical frequencies. Capability of such devices to emit radio-frequency radiation is automatically blocked on sensing the infrared system.

U.S. Pat. No. 4,352,200 (Oxman) provides a wireless aircraft passenger audio entertainment system where audio information in several audio channels is supplied via head sets to passengers seated aboard an aircraft in rows of seats including armrests and being distributed along an elongate passenger section inside a metallic fuselage. An antenna is run along the elongate passenger section of the aircraft for radio transmission inside such elongate passenger section. Individual antennas are provided for the passenger seats for receiving the radio transmission. These receiving antennas are distributed among predetermined armrests of the passenger seats.

U.S. Pat. No. 6,671,494 (James) describes a portable FM stereo RF transmitter having an audio plug extending directly or via a cable and which mates with the earphone or output jack of an audio source such as a portable battery operated CD or tape player and having no external antenna. The portable RF transmitter modulates audio signals from the audio source onto an FM carrier and transmits them to an FM receiver mounted on a headset worn by a user.

U.S. Patent Application 2004/125,958 (Brewster, et al. details an audio system that provides for localized wireless audio communication includes a controller and headphones. The controller encodes the audio information for transmission as a wireless signal representing audio information. The headphones receive the wireless signal and reproduce the audio information, wherein encoding the audio information includes providing an authentication uniquely associating the controller and the headphones, and reproducing the audio information includes verifying the authentication so that audio information represented by wireless signals from a source other than the controller is not reproduced.

U.S. Patent Application 2003/182,003 (Takashima) describes a playback apparatus where music data is read out from a recording medium, is decoded by a decoder, and the decoded music data is transmitted from a digital wireless transmitter to the headphone in the form of digital. In the wireless headphone, the music data transmitted is received by a digital wireless receiver, the received music data is temporarily saved in a buffer memory, the saved music data is read out from the buffer memory, the readout data is converted by a D/A converter from digital data into an analog signal, and the analog signal is converted into sound via loudspeakers.

U.S. Patent Application 2002/0160773 (Gresham, et al.) teaches a system for permitting passengers on board an aircraft to send and receive electronic data. The components of the system on board the aircraft include a server that has nodes to which computer terminals are attached. The components of the system on board the aircraft include a wireless access point with multiple nodes, where the wireless access point is attached to the server and to a multiple wireless cards inserted into computer terminals. The computer terminals are laptop or palm-top personal computers belonging to the various passengers on board or fixed terminals within the aircraft. The server communicates with a wide variety of different terminals running different operating systems and with the access point. Each computer terminal is connected to the server via an aircraft cable or wireless network. The server is connected to server is one or more radios to permit data to be transferred to base station using communications network. A virtual private network (VPN) connects station to communications service provider networks, web content processor, and via links to the Internet, including access to subscriber ISPs/corporate mail servers and other mail servers. Points of Presence (POP) provide Internet access and e-mail service to subscribers of the service while not on the aircraft. POPs can also be used by communications service provider networks and web content processors as an alternate means to connect to VPN.

U.S. Patent Application 2005/0216938 (Brady, et al.) provides an in-flight entertainment system with wireless communication among components. The in-flight entertainment (IFE) system includes a network with a wireless router for communicating wirelessly between a network server and one or more video display unit (VDU) in the cabin. The wireless transmission of video signals provides a reduced architecture that avoids a need for cables to carry a signal to the VDU's. In an embodiment, the IFE system further facilitates the use of a remote wireless device, such as a laptop computer, as the VDU. Clients may select from a variety of programs which can be distributed in an on-demand or broadcast manner. Encryption means are further provided to enable control over content distribution to only authorized devices.

U.S. Patent Applications 2004/0183346 and 2003/0107248 (Sanford, et al.) describes an aircraft seat assembly including at least one electronic component usable by a passenger and a single integrated electronic systems which provides signal decoding, signal routing, data management, built in test, and power conversion for each user accessible electronic component which is installed in the seat assembly. The electronic components generally include at least a video display unit, an audio system, or a telephone. The integrated electronics system provides power conversion, signal routing, data management and other electronic requirements for each of the electronic components. The electronic components employ wireless communications for the signal routing.

U.S. Patent Application 2004/0077308 (Sanford, et al.) illustrates wireless data transmission in between seat rows in aircraft. A video display unit is mounted on a seat back. The video display unit includes a processor, a video display electrically coupled to the processor, a component configured for wireless communication with the processor, and a receiver electrically coupled to the processor. A user interface is mounted on an armrest. The user interface includes a user input interface and a wireless transmitter electrically coupled to the user input interface.

### SUMMARY OF THE INVENTION

An object of this invention is to provide an individual wireless in-flight entertainment distribution system.

Another object of this invention is to provide a wireless communication apparatus that connects to an in-flight entertainment system of an aircraft to wirelessly transmit audio content of the in-flight entertainment system to headphones of a passenger.

To accomplish at least one of these objects, a wireless in-flight entertainment distribution system incorporated within an aircraft includes an in-flight entertainment distribution apparatus and a wireless communication apparatus. The in-flight entertainment distribution apparatus contains a plurality of audio signals for the communication to passengers within a cabin of an aircraft.

The wireless communication apparatus is in communication with the in-flight distribution apparatus for communication of the audio signal to a headphone worn by the passenger. The wireless communication apparatus has a connector having a plurality of terminals wherein at least one of the terminals is in contact with a mating connector of the in-flight entertainment distribution to receive the audio signal. The connector is connected to a transmission apparatus. The transmission apparatus has a converting device in communication with the connector to acquire the audio signal for conversion to digital data words representing an amplitude of the audio signal at periodic intervals. A packet forming device collects groups of the digital data words into data packets and a frame formatting device forms the data packets into data frames having synchronization, control, error detection blocks appended to the data packets.

A channel selecting device chooses a transmission channel having at least one fundamental frequency on which the transmission device transmits the data frames. A modulating device is in communication with the channel selecting device to receive the fundamental frequency for modulating with the data frames received from the frame formatting device. A driving device is in communication with the modulating device to receive the fundamental frequency modulated with the data frames, amplifying the fundamental frequency modulated with the data frames. A transducer is in communication with the driving device to receive the amplified fundamental frequency modulated with the data frames, the amplified fundamental frequency modulated with the data frames generating a transmission signal through a transmission media.

The connector has at least one terminal that is in contact to receive a power supply voltage from a power supply voltage source associated with the audio source. The wireless in-flight entertainment distribution system further includes a power supply conditioning device in communication with the connector to receive and condition the power supply voltage for providing energy to the transmission apparatus.

The transmission channel may an RF band having multiple sub-channels that are periodically changed to transmit the data frames on different sub-channels at different times to prevent interference from other wireless in-flight entertainment distribution systems and may adhere to the Bluetooth protocol. In this case transducer is an antenna and the transmission signal is a radio frequency electromagnetic emission. Alternately, the transducer is a magnetic coupling device and the transmission signal is a magnetic field or the transducer is a capacitive coupling device and the transmission signal is an electrical field.

The wireless communication apparatus may be incorporated in a portable package where the connector is connected to a receiving connector incorporated in an armrest of an aircraft seat and from the armrest to the in-flight distribution apparatus. In a second embodiment, the wireless communication apparatus may be incorporated within an armrest of an aircraft seat and the connector is connected to cabling distribution network of the in-flight distribution apparatus.

The wireless in-flight entertainment distribution system further includes a receiving apparatus for receiving the transmission signal from the transmission media, for demodulating the transmission signal, for depacketizing and decoding to recover the audio signal for transmission to the headset.

### BRIEF DESCRIPTION OF THE DRAWINGS

FIG. 1 illustrates an in-flight entertainment distribution system of the prior art within an aircraft.

FIG. 2 illustrates a passenger seat including an in-flight entertainment system of the prior art.

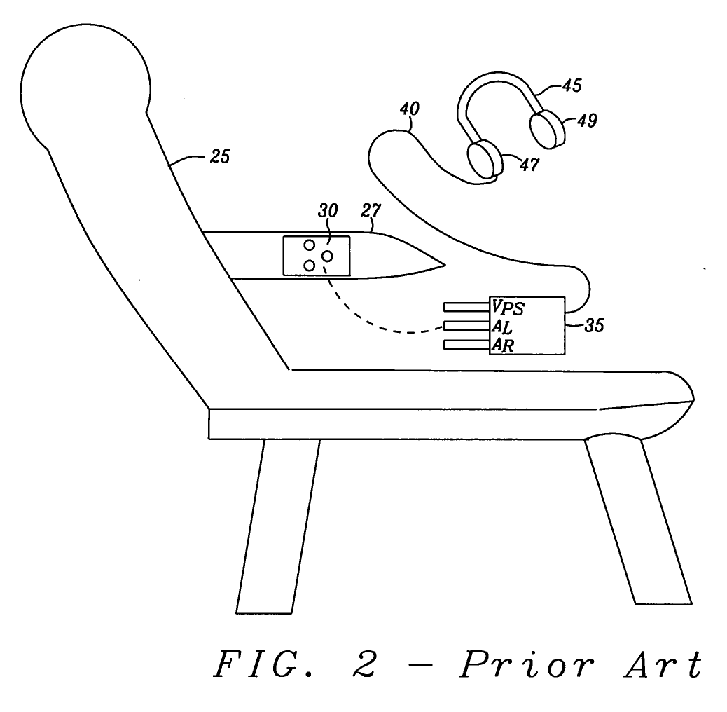

FIG. 3a illustrates a first embodiment of a passenger seat including an in-flight entertainment system of this invention.

FIG. 3b illustrates a second embodiment of a passenger seat including an in-flight entertainment system of this invention.

FIG. 4 is a block diagram of transmission apparatus of a wireless in-flight entertainment distribution system of this invention.

FIG. 5 is block diagram of a receiver apparatus of a wireless in-flight entertainment distribution system of this invention.

### DETAILED DESCRIPTION OF THE INVENTION

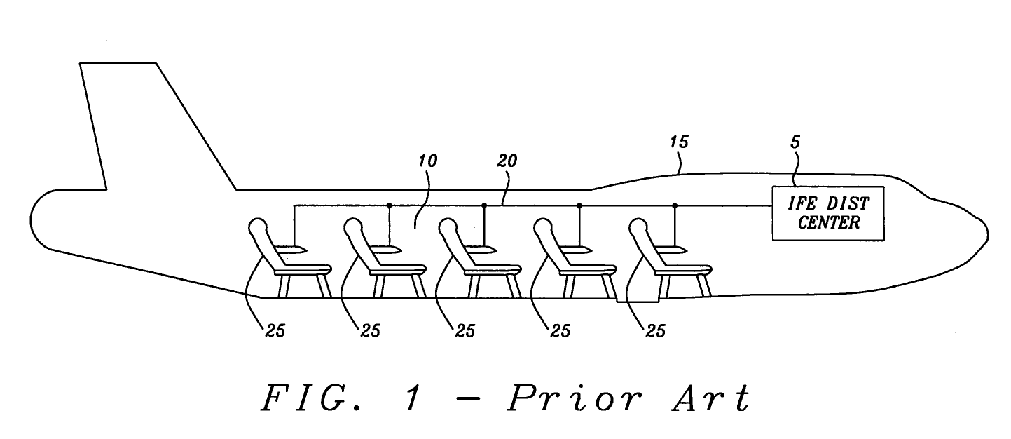

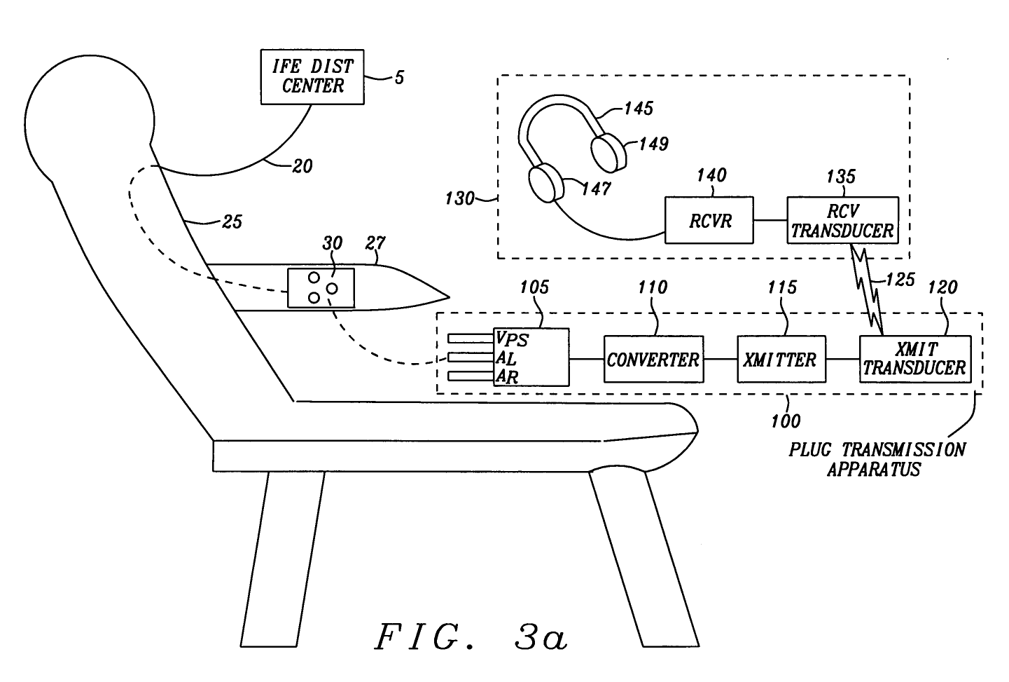

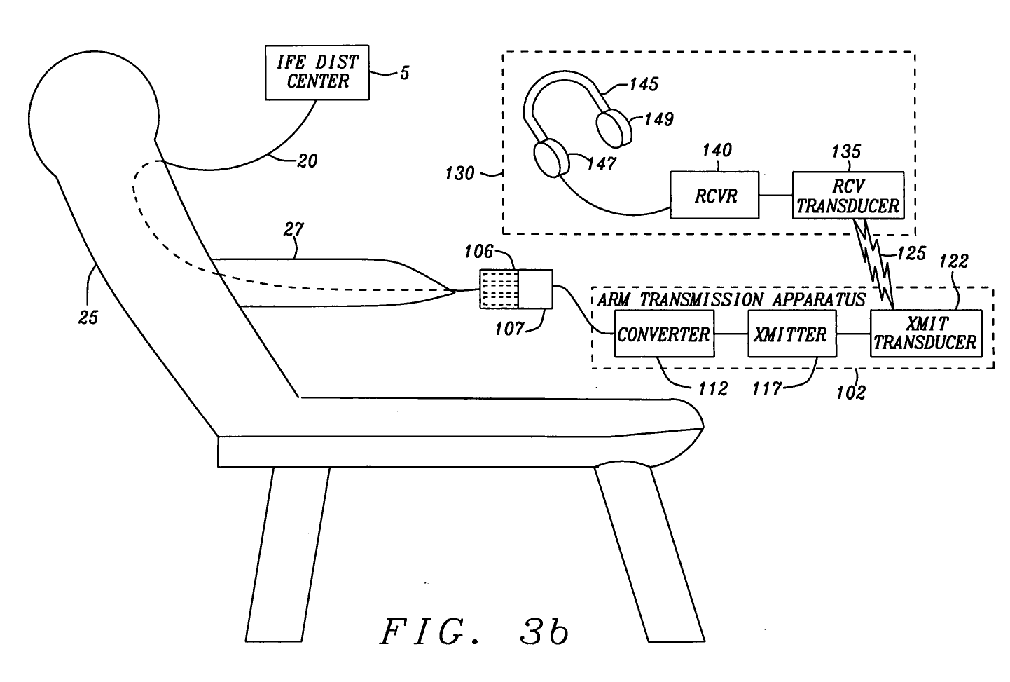

The in-flight entertainment distribution system of this invention is incorporated within a passenger cabin of an aircraft and has a distribution system which contains recorded audio (musical) content similar to that shown in FIG. 1. The content is reproduced as an analog audio signal transferred on a physical cabling distribution network to each passenger seat. In the first embodiment of the in-flight entertainment distribution system of this invention as shown in FIG. 3a, the cabling distribution network 20 from the a distribution system 5 is placed within each passenger seat 25 such that it terminates in a “female” type connector 30 placed in the armrest 27. The transmission apparatus 100 of this invention has a “male” plug connector 105 that is inserted into the female connector 30 to make contact with the cabling distribution network to receive the analog audio signals.

Generally, the analog audio signal is a stereo audio signal and one terminal of the male plug connector 105 has one terminal connected to provide a left audio signal A_{L} and a second terminal connected to provide the right audio signal A_{R}. Additionally, the armrest 27 of the seat 25 may have a switch (not shown) for selecting various channels of analog audio signal. Each channel containing a pair of the left audio signal A_{L} and the right audio signal A_{R} and having a different audio content.

The plug transmission apparatus 100 is physically joined and integrated with the male plug connector to be a portable device that plugs into the female connector 30 in the arm 27 of the aircraft seat 25. The plug transmission apparatus 100 has a converter 110 that receives the analog audio signals from the connector 105 and converts them to frames of packetized digital data. The frames of packetized digital data are transferred to a transmitter 115 to modulate a fundamental frequency generated by the transmitter 115. The transmitter 115 may generate multiple frequencies which are used in a frequency “hopping” pattern to avoid interference with other similar transmitters. The fundamental frequency is then drives the transmitting transducer 120 for radiation 125 to a receiving apparatus 130.

The receiving apparatus 130 has a receiving transducer to receive the radiation 125 from the transmission apparatus 100 and converts the radiation to a received electrical signal. The received electrical signal is acquired by the receiver 140 which for demodulates received electrical signal, depacketizes and decodes the received electrical to recover the analog audio signal. The analog audio signal is then transferred to the headphones 145 for reproduction of the analog audio signal as sound from the speakers 147 and 149.

In the second embodiment of the in-flight entertainment distribution system of this invention as shown in FIG. 3b, the cabling distribution network 20 from the a distribution system 5 is placed within each passenger seat 25 such that it terminates in a “female” type connector 106 placed with in the armrest 27. The transmission apparatus 102 of this invention has a “male” plug connector 107 that is inserted into the female connector 106 to make contact with the cabling distribution network to receive the analog audio signals.

Generally, the analog audio signal is a stereo audio signal and one terminal of the male plug connector 107 has one terminal connected to provide a left audio signal A_{L} and a second terminal connected to provide the right audio signal A_{R}. Additionally, the armrest 27 of the seat 25 may have a switch (not shown) for selecting various channels of analog audio signal. Each channel containing a pair of the left audio signal A_{L} and the right audio signal A_{R} and having a different audio content as shown in FIG. 3a.

The arm transmission apparatus 102 is physically integrated within the arm 27 of the aircraft seat 25. The transmission apparatus 102 has a converter 112 that receives the analog audio signals from the connector 107 and converts them to frames of packetized digital data. The frames of packetized digital data are transferred to a transmitter 117 to modulate a fundamental frequency generated by the transmitter 117. The transmitter 117 may generate multiple frequencies which are used in a frequency “hopping” pattern to avoid interference with other similar transmitters. The fundamental frequency is then drives the transmitting transducer 122 for radiation 125 to a receiving apparatus 130. The transmitting transducer 122 is constructed into the arm 27 to allow the radiation 125 to the receiving apparatus 130

The receiving apparatus 130 has a receiving transducer to receive the radiation 125 from the arm transmission apparatus 102 and converts the radiation to a received electrical signal as described above for FIG. 3a.

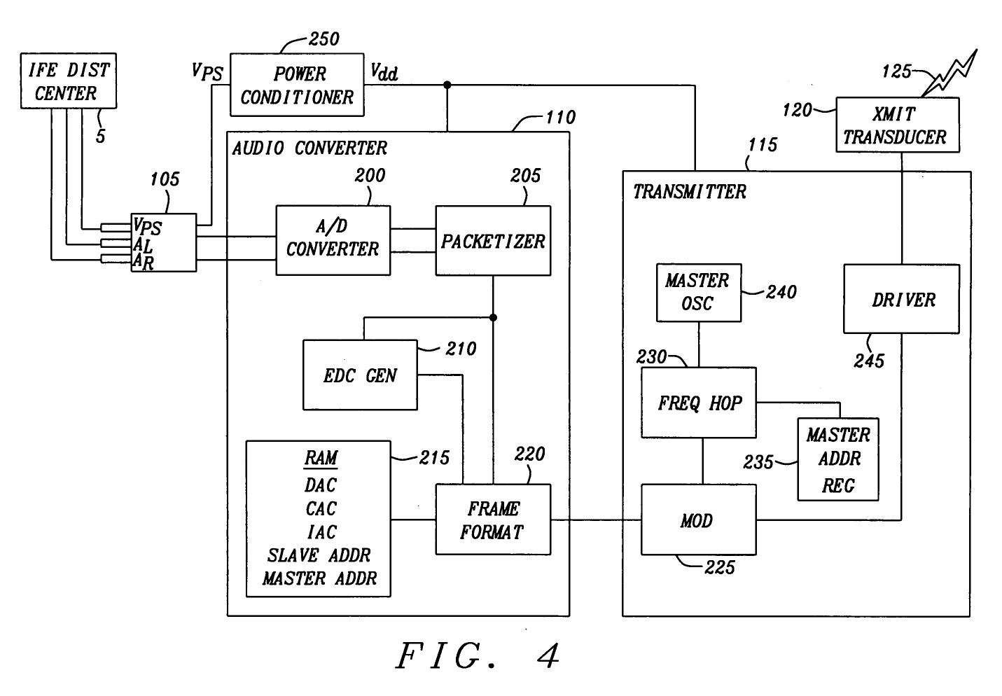

For a more detailed description of the transmission apparatus 100, refer now to FIG. 4. The male plug connector 105 is integrated with the transmission apparatus 100 to form a single small package for plugging into the female connector 30 of the passenger seat 25 as described for FIG. 3a. Alternately, the male plug connector 107 is included with the arm transmission apparatus 102 and built into the arm 27 of the passenger seat 25. The audio converter 110 has an analog-to-digital converter 200 that is communication with two terminals of the male plug connector to receive the left analog audio signal A_{L} and the right analog audio signal A_{R}. The analog-to-digital converter 200 periodically samples the left analog audio signal A_{L} and the right analog audio signal A_{R} and converts the left analog audio signal A_{L} and the right analog audio signal A_{R} to digital data words representing an amplitude of the left analog audio signal A_{L} and the right analog audio signal A_{R} at the periodic intervals.

The digital data words are then transferred to the packetizer 205 which then collected into groups of digital data words to form packets. The packets are then transferred from the packetizer 205 to an error detection circuit 210 to generate any detection (or correction) codes for the packets. The packets of the digital data words and the error detection (or correction) codes are then transferred to the frame formatter 220. The frame formatter 220 constructs data frames having synchronization, control, error detection blocks appended to said data packets. The frame formatter 220 is connected to a random access memory (RAM) 215 to receive the necessary Access codes for the transmission apparatus to communicate with the mating receiving apparatus with other transmitters in close proximity.

The RAM 215 has a Channel Access Code (CAC), a Device Access Code (DAC) and a Inquiry Access Code (IAC). The channel access code identifies a unique personal area net on which the transmission apparatus 100 of FIG. 3a or 102 of FIG. 3b is operating. The DAC is used for paging and its responses and the IAC is used for inquiry purpose. The CAC, DAC, and IAC are included in the header information of the frames by the frame formatter 220.

The formatted frames of the digital data are then passed to modulator 225 of the transmitter 115. The master oscillator 240 generates a fundamental frequency which is to be modulated by the frames of digital data. The fundamental frequency is transferred to a frequency hopping circuit 235 which adjusts the fundamental frequency to vary or hop the fundamental frequency according to a pattern as determined by an address stored in the master address register 230. The frequency hopping circuit selects the channel frequencies for the modulation and transfers the varying fundamental frequency to the modulator for modulation with the frames of the modulator 225. The modulated fundamental frequency is then transferred to the driver circuit 245 of amplification and conditioning. The fundamental frequency is then used to drive the transmitter transducer 120 to generate the radiation signal 125 through a transmission media such as the air of the aircraft cabin.

In the preferred embodiment, the transmitter transducer 120 is an antenna and the radiation 125 is a radio frequency (RF) wave transmitted through the air of the cabin of the aircraft. Alternately, it is keeping with the intent of this invention that the radiation 125 is light such as infrared light, or a magnetic field modulated with the frames of the digital data. The radiation 125 is intended to have limited range and provide no interference with other transmission apparatus 100 within the aircraft cabin.

The female connector 30 of FIG. 3 has a terminal that is connected through the cabling network to a power supply voltage source either integrated in or associated with the in-flight entertainment distribution system 5 of FIG. 1. The male plug connector 105 or 107 has a terminal that engages the terminal of the female connector to conduct the power supply voltage V_{PS} to the power conditioner 250. The power conditioner 250 conditions the power supply voltage V_{PS} to generate the voltage V_{dd} to provide the necessary energy to power the transmission apparatus 100 of FIG. 3a or 102 of FIG. 3b. Alternately, in connector structures, where there are no connections to the power supply voltage source V_{PS}, the power conditioner 250 may be connected to a battery.

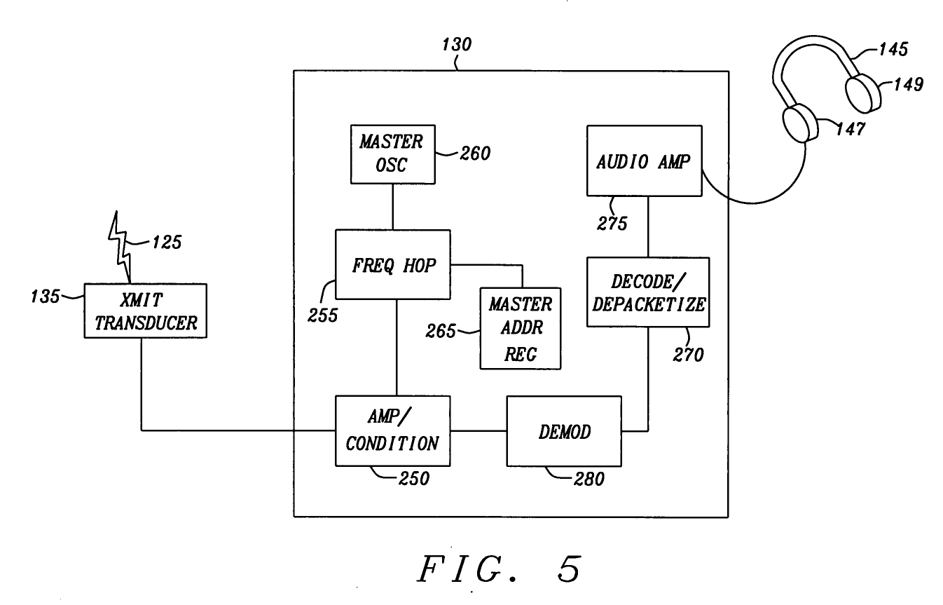

The radiation 125, as shown in FIG. 5, impinges upon the receiving transducer 135 to convert the radiation 125 to an electrical signal. The electrical signal is transferred to the amplifier and conditioner circuit 250. The master oscillator 260 generates a fundamental frequency that is approximately equal to the fundamental frequency of the transmission apparatus 100 of FIG. 3a or 102 of FIG. 3b. A frequency hopping circuit 255 is connected to the master oscillator 260 to adjust the fundamental frequency to vary or hop the fundamental frequency according to a pattern as determined by an address stored in the master address register 265. Generally the DAC is used to determine the hopping pattern of the fundamental frequency. The fundamental frequency is applied to the amplifier and conditioner circuit 255 and combined with the electrical signal to recover the transmitted modulated fundamental frequency. The recovered modulated fundamental frequency is transferred to the demodulator 280, where it is demodulated to recover the frames of digital data.

The recovered frames of digital data are then transferred to the decode/depacketization circuit 270. The recovered frames of digital data are then decoded, depacketized, and converted to the digital data. The digital data is then converted to an analog signal that is passed to the audio amplifier 275. The amplified audio signal is then transferred to the speakers 147 and 149 of the headphones 145.

In the preferred embodiment, the in-flight entertainment distribution system employs a wireless digital network protocol such as Bluetooth. In a system that employs a magnetic field as the radiation transport, the system is a near-field magnetic wireless system that utilizes a modulated non-propagating quasi-static magnetic field. The modulated magnetic field is generated by a transducer element remains relatively localized around the transmitting device. The quasi-static characteristic of the field is the result of the transducer geometry in combination with the carrier frequency of the transmitter. Information is “coupled” through the medium by sensing the time varying magnetic field using a similarly designed magnetic transducer at the receiver. The magnetic transducer of the transmitter induces the carrier frequency signal to the magnetic transducer of the receiver.

An alternate to the near-field magnetic transport as described is a near field electric transport, where the radiation transport of the carrier signal is an electrical field. In this embodiment, the transmitter transducer and the receiver transducers are capacitively coupled such that the carrier signal is transmitted between through the electrical field of the capacitive coupling.

In summary, a wireless in-flight entertainment distribution apparatus distributes a plurality of audio signals within an aircraft. The wireless in-flight entertainment distribution apparatus acquires the plurality of audio signals from an in-flight entertainment distribution apparatus within the aircraft through a connector having a plurality of terminals. At least one of the plurality of terminals is in contact with the audio source to receive the audio signal. The audio signals are converted to digital data words representing an amplitude of the audio signal at periodic intervals. The digital data words are then collected into groups to form data packets. In turn, the data packets are formed into data frames having synchronization, control, error detection blocks appended to the data packets. Transmission channels are chosen to have at least one fundamental frequency on which the transmission device transmits the data frames. The fundamental frequency is then modulated with the data frames received. The modulated fundamental frequency is amplified and a transducer such as an antenna is driven with the amplified fundamental frequency modulated with the data frames to generate a transmission signal through a transmission media.

The connector has at least one terminal that is in contact to receive a power supply voltage from a power supply voltage source associated with the audio source. The transmission apparatus receives the power supply voltage and conditions the power supply voltage for providing energy for performing the method for wireless in-flight entertainment distribution.

In the preferred embodiment as described above the transducer is an RF antenna and the transmission channel is an RF band having multiple sub-channels that are periodically changed to transmit the data frames on different sub-channels at different times to prevent interference. Further, in the preferred embodiment the forming of the data packets and frames of the digital data words and the frequency “hopping” adheres to the Bluetooth protocol. Alternately, the transducer is a magnetic coupling device and the transmission signal is a magnetic field.

The wireless in-flight entertainment distribution further receives the transmission signal from the transmission media. The transmission signal is then demodulated, depacketized, and decoded to recover the audio signal. The recovered audio signal is then transmitted to the speaker.

It should be noted that it is in keeping with the intent of this invention that the “female” type connector 30 placed in the armrest 27 into which the plug transmission apparatus 100 is plugged of FIG. 3a and the arm transmission apparatus 102 of FIG. 3b may be placed together in the armrest 27. The plug transmission apparatus 100 is plugged into the “female” type connector 30 in the armrest 27 and the arm transmission apparatus 102 is disabled to prevent transmission of the radiation 125 from the arm transmission apparatus 102 and allow transmission of the radiation 125 from the plug transmission apparatus 100. The “female” type connector 30 in the armrest 27 maybe configured to interrupt the connection from the physical cabling distribution network 20 to the arm transmission apparatus 102 and connect the plug transmission apparatus 100. Alternately, the arm transmission apparatus 102 may sense the presence of the plug transmission apparatus 100 and disable its own transmission of the radiation 125.

While this invention has been particularly shown and described with reference to the preferred embodiments thereof, it will be understood by those skilled in the art that various changes in form and details may be made without departing from the spirit and scope of the invention.

The invention claimed is:

1. A digital wireless communication system for the communication of at least one analog signal from at least one analog source to at least one analog signal reproduction device, said digital wireless communication system comprising:
a connector having a plurality of terminals wherein at least one of said plurality of terminals is in contact with said analog source to receive said analog signal;
a transmission apparatus comprising:
a converting device in communication with said connector to acquire said analog signal for conversion to digital data words representing an amplitude of said analog signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus is integrated with said connector in a portable package;
wherein said connector is a male connector plugged to a female connector integrated into an arm of an aircraft seat such that said digital wireless communication system is connected to an in-flight-entertainment distribution system of an aircraft; and
wherein said analog signal from said audio source is an audio signal provided by said in-flight-entertainment distribution system.

2. A digital wireless communication system for the communication of at least one analog signal from at least one analog source to at least one analog signal reproduction device, said digital wireless communication system comprising:
a connector having a plurality of terminals wherein at least one of said plurality of terminals is in contact with said analog source to receive said analog signal;
a transmission apparatus comprising:
a converting device in communication with said connector to acquire said analog signal for conversion to digital data words representing an amplitude of said analog signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus and said connector are integrated within an arm of an aircraft seat;
wherein said connector is a male connector plugged to a female connector of an in-flight-entertainment distribution system to connect said digital wireless communication system to said in-flight-entertainment distribution system of said aircraft; and
wherein said analog signal from said audio source is an audio signal provided by said in-flight-entertainment distribution system.

3. A wireless in-flight entertainment distribution system incorporated within an aircraft comprising:
an in-flight entertainment distribution apparatus for the communication of a plurality of audio signals;
a wireless communication apparatus in communication with said in-flight distribution apparatus for communication of said audio signal to a headphone, said wireless communication apparatus comprising:
a connector having a plurality of terminals wherein at least one of said plurality of terminals is in contact with said audio source to receive said audio signal;
a transmission apparatus comprising:
a converting device in communication with said connector to acquire said audio signal for conversion to digital data words representing an amplitude of said audio signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus is integrated with said connector in a portable package; and
wherein said connector is a male connector plugged to a female connector integrated into said arm of a seat of said aircraft such that said digital wireless communication system is connected to an in-flight entertainment distribution apparatus to receive one of said plurality of audio signals provided by said in-flight entertainment distribution apparatus.

4. A wireless in-flight entertainment distribution system incorporated within an aircraft comprising:
an in-flight entertainment distribution apparatus for the communication of a plurality of audio signals;
a wireless communication apparatus in communication with said in-flight distribution apparatus for communication of said audio signal to a headphone, said wireless communication apparatus comprising:
a connector having a plurality of terminals wherein at least one of said plurality of terminals is in contact with said audio source to receive said audio signal;
a transmission apparatus comprising:
a converting device in communication with said connector to acquire said audio signal for conversion to digital data words representing an amplitude of said audio signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus and said connector are integrated within said arm of said seat of said aircraft; and
wherein said connector is a male connector plugged to a female connector of said in-flight entertainment distribution apparatus to connect said digital wireless communication system to said in-flight entertainment distribution apparatus for the distribution of said audio signals.

5. An in-flight entertainment wireless communication apparatus in communication with an in-flight distribution system for communication of one of a plurality of audio signals to a headphone, said wireless communication apparatus comprising:
a connector having a plurality of terminals wherein at least one of said plurality of terminals is in contact with said in-flight distribution system to receive said audio signal;
a transmission apparatus in connected to said connector and comprising:
a converting device in communication with said connector to acquire said audio signal for conversion to digital data words representing an amplitude of said audio signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus is integrated with said connector in a portable package; and
wherein said connector is a male connector plugged to a female connector integrated into said arm of a seat of said aircraft such that said digital wireless communication system is connected to an in-flight entertainment distribution apparatus to receive one of said plurality of audio signals provided by said in-flight entertainment distribution apparatus.

6. An in-flight entertainment wireless communication apparatus in communication with an in-flight distribution system for communication of one of a plurality of audio signals to a headphone, said wireless communication apparatus comprising:
a connector having a plurality of terminals wherein at least one of said plurality of terminals is in contact with said in-flight distribution system to receive said audio signal;
a transmission apparatus in connected to said connector and comprising:
a converting device in communication with said connector to acquire said audio signal for conversion to digital data words representing an amplitude of said audio signal at periodic intervals,
a packet forming device in communication with said converting device for collecting groups of said digital data words into data packets,
a frame formatting device in communication with said packet forming device for forming said data packets into data frames having synchronization, control, error detection blocks appended to said data packets,
a channel selecting device for choosing a transmission channel having at least one fundamental frequency on which said transmission device transmits said data frames,
a modulating device in communication with said channel selecting device to receive said fundamental frequency for modulating with said data frames received from said frame formatting device,
driving device in communication with said modulating device to receive said fundamental frequency modulated with said data frames, amplifying said fundamental frequency modulated with said data frames, and
a transducer in communication with said driving device to receive said amplified fundamental frequency modulated with said data frames, said amplified fundamental frequency modulated with said data frames generating a transmission signal through a transmission media;
wherein said transmission apparatus and said connector are integrated within said arm of said seat of said aircraft; and
wherein said connector is a male connector plugged to a female connector of said in-flight entertainment distribution apparatus to connect said digital wireless communication system to said in-flight entertainment distribution apparatus to receive one of said plurality of audio signals provided by said in-flight entertainment distribution apparatus.

7. A method for wireless communication of an audio signal from an audio source to at least one audio signal reproduction device, said method comprising the steps of:
acquiring said audio signal from said audio source through a connector having a plurality of terminals;
providing a transmission apparatus in communication with said connector to receive said audio signal wherein said transmission apparatus executes the steps of:
converting said audio signal to digital data words representing an amplitude of said audio signal at periodic intervals,
forming groups of said digital data words into data packets,
formatting said data packets into data frames having synchronization, control, error detection blocks appended to said data packets,
selecting a transmission channel having at least one fundamental frequency on which said transmission device transmits said data frames,
modulating said fundamental frequency with said data frames,
transmitting said fundamental frequency modulated with said data frames from a transducer to a transmission media;
integrating said transmission apparatus with said connector to form a portable package;
integrating a female connector into an arm of a seat of an aircraft; and
plugging said connector is a male connector to said female connector such that said digital wireless communication system is connected to an in-flight entertainment distribution apparatus within said aircraft to receive one of said plurality of audio signals provided by said in-flight entertainment distribution apparatus.

8. A method for wireless communication of an audio signal from an audio source to at least one audio signal reproduction device, said method comprising the steps of:
acquiring said audio signal from said audio source through a connector having a plurality of terminals;
converting said audio signal to digital data words representing an amplitude of said audio signal at periodic intervals,
forming groups of said digital data words into data packets,
formatting said data packets into data frames having synchronization, control, error detection blocks appended to said data packets,
selecting a transmission channel having at least one fundamental frequency on which said transmission device transmits said data frames,
modulating said fundamental frequency with said data frames,
transmitting said fundamental frequency modulated with said data frames from a transducer to a transmission media;
integrating said transmission apparatus and said connector within an arm of a seat of an aircraft; and
plugging said connector is a male connector to said female connector such that said digital wireless communication system is connected to an in-flight entertainment distribution apparatus to receive one of said plurality of audio signals provided by said in-flight entertainment distribution apparatus.
